(19) United States
(12) Patent Application Publication
(10) Pub. No.: US 2024/0390828 A1
(43) Pub. Date: Nov. 28, 2024

(54) DEVICE AND METHOD FOR HARMLESS TREATMENT AND REGENERATION OF WASTE LIQUID DISCHARGE DURING WATER GLASS MOLD SHELL HARDENED WITH AMMONIUM CHLORIDE SOLUTION

(71) Applicant: Inner Mongolia University of Technology, Hohhot City (CN)

(72) Inventors: Chang LIU, Hohhot City (CN); Zhongxing TIAN, Hohhot City (CN); Xiangdong LIU, Hohhot City (CN); Hua FENG, Hohhot City (CN); Yuecheng ZHANG, Hohhot City (CN)

(21) Appl. No.: 18/671,537

(22) Filed: May 22, 2024

(30) Foreign Application Priority Data
May 23, 2023 (CN) 202310584870.7

(51) Int. Cl. B01D 36/00; B01D 3/14; B01D 24/00; B01D 24/12; B01D 24/46; B01D 53/18; B22C 1/00; C01C 1/16; C01D 3/08; C04B 22/12; C04B 28/00

(52) U.S. Cl. CPC B01D 36/008; B01D 3/143; B01D 24/007; B01D 24/12; B01D 24/4631; B01D 53/18; B22C 1/00; C01C 1/164; C01D 3/08; C04B 22/124; C04B 28/008; B01D 2101/04; B01D 2257/406

(57) ABSTRACT

A harmless treatment and regeneration device and method thereof of waste liquid discharge from failed hardener solution during hardening of water glass mold shell via ammonium chloride solution are provided. The device includes a waste liquid storage tank, a filtering mechanism, a regeneration mechanism, and a regeneration liquid storage tank. A fluid outlet end of the waste liquid storage tank is in fluid communication with a fluid inlet end of the filtering mechanism, a fluid outlet end of the filtering mechanism is in fluid communication with a fluid inlet end of the regeneration mechanism, and a fluid outlet end of the regeneration mechanism is in fluid communication with a fluid inlet end of the regeneration liquid storage tank.

### CROSS-REFERENCE TO RELATED APPLICATION

This patent application claims the benefit of and priority to Chinese Patent Application No. 202310584870.7 filed with the Chinese Patent Office on May 23, 2023, which is hereby incorporated by reference herein in its entirety.

### TECHNICAL FIELD

The present disclosure relates to the technical field of water glass mold shell hardened, and in particular to a device and method for harmless treatment and regeneration of waste liquid discharge during a water glass mold shell hardened with ammonium chloride solution.

### BACKGROUND

Water glass is widely used in production of investment casting mold shell due to its advantages of no toxicity and low cost. Various types of hydrochloric acid solutions with weak acidity are often used as hardeners for the hardening of water glass mold shells, among which ammonium chloride solution is the most commonly used. The main reason is that the permeability of ammonium chloride solution is good, the depth of hardened layer of the mold shells is large, and the strength of the hardened mold shells is high. However, when ammonium chloride solution is used to harden the water glass mold shells, the main problem is that three by-products, including sodium chloride, ammonia gas and water are produced by hardening reaction. Sodium chloride, due to its high density, is deposited at a bottom of the hardening tank, the continuous accumulation of sodium chloride changes the concentration of the hardener solution and the relative content of effective components, resulting in the constant change of physical and chemical properties of the hardener solution with usage cycle and frequency. Even if the effective components are added in time, it is difficult to avoid the problem that the physical and chemical properties are constantly changed due to the pollution of the hardener solution and the consumption of the effective components.

Therefore, ammonium chloride solution is required to be replaced with fresh one in time after a certain period of use, so as to ensure that the hardening performance of the mold shells meets the requirements. In addition, the volatilization of ammonia gas, a by-product of hardening reaction with strong irritation, poisons shell-making operation environment and endangers the safety and occupational health of employees. Under current environmental protection standards, the investment casting industry with high energy consumption, high pollution, and high emission is facing unprecedented pressure and challenges. As far as the shell-making process of hardening the water glass mold shells with ammonium chloride is concerned, how to prevent the volatilization of ammonia gas and effectively treat high-salt-containing waste liquid has become a difficult problem that troubles enterprises for a long time and needs to be solved urgently.

Although many enterprises have used other low-volatile hydrochloride solutions instead of ammonium chloride solution as the hardener for water glass mold shells, the production of sodium chloride, a by-product of the hardening reaction, and the accumulation of sodium chloride in the hardener solution are always unavoidable. It is difficult to recycle the high-salt hardener waste liquid, and the environmental pollution caused by direct discharge has not been effectively and thoroughly solved for a long time, resulting to serious restriction on the development of the investment casting industry. Therefore, it is an inevitable choice and irresistible trend to develop a device and related technologies for harmless treatment and regeneration of the hardener waste liquid.

### SUMMARY

To this end, the technical problem to be solved by the present disclosure is to provide a device and method for harmless treatment and regeneration of waste liquid discharge during a water glass mold shell hardened with ammonium chloride solution under normal temperature and normal pressure conditions with good adaptability and simple process, so as to solve the problem of environmental pollution caused by high-salt waste liquid and volatile toxic and harmful gases produced in the hardening process of the water glass mold shell.

To solve the technical problem above, the present disclosure provides the following technical solution:

A device for harmless treatment and regeneration of waste liquid discharge during a water glass mold shell hardened with ammonium chloride solution includes a waste liquid storage tank, a filtering mechanism, a regeneration mechanism, and a regeneration liquid storage tank. A fluid outlet end of the waste liquid storage tank is in fluid communication with a fluid inlet end of the filtering mechanism, a fluid outlet end of the filtering mechanism is in fluid communication with a fluid inlet end of the regeneration mechanism, and a fluid outlet end of the regeneration mechanism is in fluid communication with a fluid inlet end of the regeneration liquid storage tank.

According to the device for harmless treatment and regeneration of waste liquid discharge during a water glass mold shell hardened with ammonium chloride solution, the filtering mechanism includes a first-stage filter, and a second-stage filter. A first fluid inlet end of the first-stage filter is in fluid communication with the fluid outlet end of the waste liquid storage tank, a fluid outlet end of the first-stage filter is in fluid communication with a fluid inlet end of the second-stage filter, and a fluid outlet end of the second-stage filter is in fluid communication with the fluid inlet end of the regeneration mechanism.

According to the device for harmless treatment and regeneration of waste liquid discharge during a water glass mold shell hardened with ammonium chloride solution, the first-stage filter is filled with large-sized quartz powder as a filter medium, a height of a filter medium column is greater than or equal to 300 mm, and the filter medium is sieved through a 200-mesh screen. The fluid inlet end of the first-stage filter is in fluid communication with a top of the filter medium column, and the fluid outlet end of the first-stage filter is in fluid communication with a bottom of the filter medium column.

According to the device for harmless treatment and regeneration of waste liquid discharge during a water glass mold shell hardened with ammonium chloride solution, the second-stage filter is filled with small-sized quartz powder as a filter medium, a height of a filter medium column is greater than or equal to 300 mm, and the filter medium is sieved through a 325-mesh screen. The fluid inlet end of the second-stage filter is in fluid communication with a top of the filter medium column, and the fluid outlet end of the second-stage filter is in fluid communication with a bottom of the filter medium column.

According to the device for harmless treatment and regeneration of waste liquid discharge during a water glass mold shell hardened with ammonium chloride solution, the filtering mechanism further includes an air compressor pump, and an air outlet end of the air compressor pump is in fluid communication with a second fluid inlet end of the first-stage filter.

According to the device for harmless treatment and regeneration of waste liquid discharge during a water glass mold shell hardened with ammonium chloride solution, the regeneration mechanism includes a fractionator, a heater, an absorption tank, and a liquid mixing barrel. A fluid inlet end of the fractionator is in fluid communication with the fluid outlet end of the filtering mechanism, a fluid outlet end of the fractionator is in fluid communication with a fluid inlet end of the absorption tank, a fluid outlet end of the absorption tank is in fluid communication with a fluid inlet end of the liquid mixing barrel, and a fluid outlet end a of the liquid mixing barrel is in fluid communication with the fluid inlet end of the regeneration liquid storage tank. The fractionator is fixedly installed in a heating medium of the heater.

According to the device for harmless treatment and regeneration of waste liquid discharge during a water glass mold shell hardened with ammonium chloride solution, the regeneration mechanism further includes a pH meter, and a sampling bottle. A composite electrode of the pH meter extends below a liquid level in the sampling bottle. A fluid inlet end of the sampling bottle is in fluid communication with a fluid outlet end b of the liquid mixing barrel.

According to the device for harmless treatment and regeneration of waste liquid discharge during a water glass mold shell hardened with ammonium chloride solution, the fractionator is a spherical fractionator, and an included angle between a condensation branch of the spherical fractionator and a neck part of the spherical fractionator located below the condensation branch is in a range of 45°˜70°. The heater is a magnetic stirring oil bath heater, with a temperature control range of 100° C.˜260° C. A batching port is formed at a top of the liquid mixing barrel. An absorption medium is arranged in the absorption tank.

A method for harmless treatment and regeneration of waste liquid discharge during a water glass mold shell hardened with ammonium chloride solution is realized by using the device for harmless treatment and regeneration of waste liquid discharge during a water glass mold shell hardened with ammonium chloride solution above, and includes the following steps:
Step (1): storing waste liquid discharge during the water glass mold shell hardened with ammonium chloride solution in the waste liquid storage tank;
Step (2): conveying the ammonium chloride waste liquid in the waste liquid storage tank to the filtering mechanism for filter treatment, so as to remove solid particles from the ammonium chloride waste liquid;
Step (3): conveying the ammonium chloride waste liquid filtered by the filtering mechanism to the regeneration mechanism for regeneration treatment, so as to decompose ammonium chloride in the ammonium chloride waste liquid to produce ammonia gas and hydrogen chloride gas, and reabsorbing the ammonia gas and hydrogen chloride gas by distilled water to obtain regeneration liquid;
Step (4): analyzing and detecting chemical components in the regeneration liquid, and adding ammonia water, hydrochloric acid, or ammonium chloride solution into the regeneration liquid according to analysis and detection results to obtain ammonium chloride regeneration liquid with a target concentration; and
Step (5): conveying the ammonium chloride regeneration liquid obtained from the regeneration treatment of the regeneration mechanism to a regeneration liquid storage tank for storage and standby.

The method for harmless treatment and regeneration of waste liquid discharge during a water glass mold shell hardened with ammonium chloride solution further includes the following steps:
Introducing air into the filtering mechanism and the regeneration mechanism to wash residual waste gas and waste liquid in a pipeline, when the harmless treatment and regeneration of the ammonium chloride waste liquid is completed;
Sieving quartz powder filled in the filtering mechanism as the filter medium to be used as refractory powder for manufacturing the mold shell, when the harmless treatment and regeneration of the ammonium chloride waste liquid is completed.

The technical solution of the present disclosure has achieved the following beneficial effects:

1. Through the treatment of the device for harmless treatment and regeneration of waste liquid discharge during a water glass mold shell hardened with ammonium chloride solution provided by the present disclosure, complete regeneration of the ammonium chloride waste liquid can be achieved, the original physical and chemical properties of the ammonium chloride waste liquid can be restored, and the problems of unstable hardening performance of the mold shell caused by large chemical property changes in the process of repeated use of the hardener ammonium chloride solution with high frequency and multiple batches, as well as a series of problems such as low utilization rate of the hardener ammonium chloride solution, large emission and serious environmental pollution are solved.

2. When the device provided by the present disclosure is used for treatment and regeneration of waste liquid, each process is carried out under closed conditions, the components and physical and chemical properties of the hardener waste liquid can be regulated in real time, thus improving stability of the physical and chemical properties during the use of the hardener solution, achieving controllability of the performance of the water glass mold shell, effectively improving stability of the mechanical performance and technological performance of the water glass mold shell, reducing the reject rate of the mold shell, and reducing production costs. In addition, sodium chloride, a by-product produced in the treatment process of the hardener waste liquid, can be used as an industrial raw material to achieve resource recycling. When used for a certain period of time, quartz sand (powder) as the filter medium can be sieved and directly used as shell-making refractory powder.

3. According to the present disclosure, the problems of environmental pollution and the like caused by the direct discharge of the hardener waste liquid produced in the existing water glass mold shell process can be avoided, zero discharge of solid and liquid waste in the shell-making process of the water glass mold shell can be achieved, which is of great significance in promoting the upgrading and transformation of traditional investment casting industry, and achieving clean production and green, low-carbon, and sustainable development.

4. The device provided by the present disclosure has a simple structure, the treatment process is carried out in a closed system under normal temperature and pressure conditions, with low cost, which not only eliminates the discharge of irritating gas NH₃ and the harm to the shell-making operation environment, but also can achieve the filtration of solid particle impurities in the hardener waste liquid, the separation of high-content sodium chloride components and the complete regeneration and reuse of residual liquid, thus the problems of environmental pollution caused by the direct discharge of the waste liquid in the process of hardening the water glass mold shell by the existing ammonium chloride solution can be effectively avoided, and zero emission and clean production can be achieved. The by-product from fractionation, NaCl crystals, can be collected and used as industrial raw materials.

### BRIEF DESCRIPTION OF THE DRAWINGS

FIG. 1 is a structural schematic diagram of a device for harmless treatment and regeneration of waste liquid discharge during a water glass mold shell hardened with ammonium chloride solution according to an embodiment of the present disclosure.

In the drawings: 1 waste liquid storage tank; 2 first-stage filter; 3 second-stage filter; 4 fractionator; 5 heater; 6 absorption tank; 7 pH meter; 8 sampling bottle; 9 liquid mixing barrel; 10—regeneration liquid storage tank; 11 air compressor pump; 12 feed port; 13 large-sized quartz powder; 14 small-sized quartz powder; 15 condensation branch; 16 valve; 17 composite electrode; 18 discharge port; 19 cable.

### DETAILED DESCRIPTION

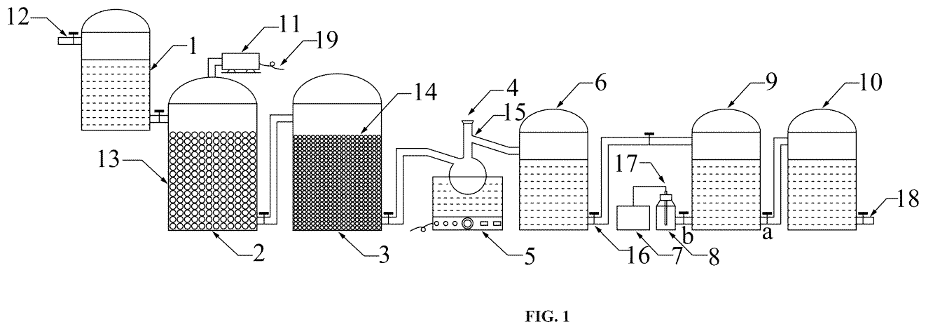

In this embodiment, a device for structural schematic diagram of a harmless treatment and regeneration of waste liquid discharge during a water glass mold shell hardened with ammonium chloride solution is shown in FIG. 1, including a waste liquid storage tank 1, a filtering mechanism, a regeneration mechanism, and a regeneration liquid storage tank 10. The filtering mechanism includes a first-stage filter 2, a second-stage filter 3, and an air compressor pump 11. The regeneration mechanism includes a fractionator 4, a heater 5, an absorption tank 6, a liquid mixing barrel 9, a pH meter 7, and a sampling bottle 8.

A fluid outlet end of the waste liquid storage tank 1 is in fluid communication with a first fluid inlet end of the first-stage filter 2, and a second fluid inlet end of the first-stage filter 2 is in fluid communication with an air outlet end of the air compressor pump 11. An air inlet, i.e., a second fluid inlet end, is arranged on a top of the first-stage filter 2, the air compressor pump 11 is in communication with the air inlet at the top of the first-stage filter 2 through a conveying pipe. After the waste liquid treatment is completed and all regeneration liquid is discharged, connecting valves among the first-stage filter 2, the second-stage filter 3, the fractionator 4, the heater 5, and the absorption tank 6 are opened, the air compressor pump 11 is turned on, and compressed air is used as a washing gas to wash the pipeline, so as to reduce the residual waste liquid and waste gas in the pipeline.

A fluid outlet end of the first-stage filter 2 is in fluid communication with a fluid inlet end of the second-stage filter 3, and a fluid outlet end of the second-stage filter 3 is in fluid communication with a fluid inlet end of the fractionator 4. A fluid outlet end of the fractionator 4 is in fluid communication with a fluid inlet end of the absorption tank 6, and a fluid outlet end of the absorption tank 6 is in fluid communication with a fluid inlet end of the liquid mixing barrel 9. A fluid outlet end a of the liquid mixing barrel 9 is in fluid communication with a fluid inlet end of the regeneration liquid storage tank 10. The fractionator 4 is fixedly installed in a heating medium of the heater 5. A composite electrode of the pH meter 7 extends below a liquid level in the sampling bottle 8. A fluid inlet end of the sampling bottle 8 is in fluid communication with a fluid outlet end b of the liquid mixing barrel 9. After the solution in the liquid mixing tank 9 is qualified after component regulation, the solution enters the regeneration liquid storage tank 10 for storage and later use through the communication of an outlet end at a lower part of the liquid mixing tank 9 and an inlet end at an upper part of the regeneration liquid storage tank 10.

In this embodiment, the composite electrode 17 of the pH meter 7 is inserted into a reserved hole of a rubber plug at an upper end of the sampling bottle 8 and kept immersed in the liquid inside the sampling bottle. The PH meter 7 is in communication with the composite electrode fixed in the sampling bottle 8 through a cable, so as to monitor the dynamic changes of a pH value of the solution in the liquid mixing tank 9 on-line. In this embodiment, the pH meter is a high-precision acidometer with the functions of automatic temperature compensation, automatic data storage, power-off protection, etc. A power supply is AC of 100˜240 V, and an output is DC of 9 V. The measurement range of the composite electrode is 0.00˜14.00 pH, with a minimum resolution of 0.01 pH, and the operation temperature is in a range of 0˜80° C.

The first-stage filter 2 is filled with large-sized quartz powder 13 as a filter medium, a height of a filter medium column is equal to 400 mm, and the filter medium is sieved through a 200-mesh screen. A fluid inlet end of the first-stage filter 2 is in fluid communication with a top of the filter medium column, and a fluid outlet end of the first-stage filter 2 is in fluid communication with a bottom of the filter medium column. The second-stage filter 3 is filled with small-sized quartz powder 14 as a filter medium, a height of a filter medium column is equal to 400 mm, and the filter medium is sieved through a 325-mesh screen. A fluid inlet end of the second-stage filter 3 is in fluid communication with a top of the filter medium column, and a fluid outlet end of the second-stage filter 3 is in fluid communication with the bottom of the filter medium column. In this embodiment, the quartz powder is high-purity quartz powder, with the content of SiO₂ in the range of 99.5˜99.9 wt % and the content of Fe₂O₃ less than or equal to 0.005 wt %. As a filter medium, high-purity quartz powder, due to its low impurity content, will not cause secondary pollution to the recovered liquid. In addition, the high-purity quartz powder with high purity and good fire resistance can meet the requirements of shell-making of mold shells and can be used to make the mold shells after being used for a period of time.

In some other embodiments, quartz sand of other particle sizes or other types of accumulation media, porous solids or woven materials may also be selected for replacement, but its filtration and purification effect is inferior to that of the quartz powder in this embodiment, and cannot be directly used as shell-making refractory powder by simple screening treatment after use. The material column may also be of other heights, and a pre-filter may be a one-stage filter or multi-stage combined filter. In this embodiment, the filter is in a shape of cylinder, and in some other embodiments, a filter in a shape of cube, cuboid or others composed of cubes, cylinders, and cuboids may also be used.

A batching port with an inner diameter of 100-150 mm is formed at a top of the liquid mixing barrel 9, which is used for component analysis and sampling, and the component regulation of the regenerated ammonium chloride solution by adding ammonia water, hydrochloric acid or ammonium chloride solution as required according to the results of the component analysis. The liquid mixing barrel 9 is made of materials with acid and alkali resistance. After the batching is completed, a valve at the batching port is closed. The absorption tank 6 is filled with an absorption medium-distilled water. The fractionator 4 is a spherical fractionator, an included angle between a condensation branch 15 of the spherical fractionator and a neck part of the spherical fractionator located below the condensation branch 15 is 60°, and a gas fractionation product in the fractionator 4 passes through an outlet end-condensation branch 15 and enters the absorption tank 5 through an upper inlet end of the absorption tank 5 connected to the conveying pipe, and the gas condensation effect is good at this inclined angle. The heater 5 is a magnetic stirring oil bath heater with the function of intelligent constant temperature control, and the temperature control range of the heater 5 is 100˜260° C. A spherical part of the fractionator 4 is immersed in the constant temperature oil bath heater for heating, and magnetic stirring is adopted, and a stirrer has the properties of acid and alkali resistance and high temperature resistance.

In this embodiment, the waste liquid storage tank, the absorption tank, the liquid mixing tank, and the regeneration liquid storage tank are all tanks or barrels made of materials with acid and alkali resistant. In some other embodiments, the device may also be in a shape of cube or cuboid, or others composed of cubes, cylinders and cuboids.

In this embodiment, a feed port 12 is formed on the waste liquid storage tank, a discharge port 18 is formed on the regeneration liquid storage tank. Valves are installed on connecting pipes among the waste liquid storage tank 1, the first-stage filter 2, the second-stage filter 3, the fractionator 4, the absorption tank 6, the liquid mixing barrel 9, and the regeneration liquid storage tank 10. A valve is also installed on the connecting pipeline between the sampling bottle 8 and the liquid mixing barrel 9.

In this embodiment, according to the harmless treatment and regeneration device of waste liquid discharge during a water glass mold shell hardened with ammonium chloride solution, the hardener waste liquid (mother liquid) in the waste liquid storage tank is conveyed through the pipeline, and is subjected to secondary pre-filtration, fractionation, absorption, component and property control (liquid mixing), collection and storage, residual waste gas absorption, etc., and finally achieves waste liquid recycling. The whole waste liquid treatment process is carried out in a closed container. After each stage of reaction is finished, the air can be introduced as a washing gas to discharge all residual gas to the next stage of treatment unit. During the whole process, various solutions are always kept in the closed container or reactor for reaction, without any waste liquid or waste gas being discharged, which has no pollution to the environment. The regeneration liquid obtained by treatment may be used as a hardener for secondary utilization to achieve the harmless treatment and resource utilization of the residual waste liquid of the water glass hardener solution, which is beneficial for the casting enterprises to achieve clean production and green production. Sodium chloride, a solid product produced in the process of waste liquid treatment, can be used as industrial raw material after being collected, so as to achieve resource utilization. When being used for a certain period of time, quartz powder as a filter medium can be directly used as shell-making refractory powder after sieving. The filter medium has strong solid particle capturing ability and high filtering efficiency. Slag discharge, cleaning and regeneration are not needed, and the filter medium can be directly used as shell-making refractory powder after simple sieving, with low filtration cost and near zero emission in the filtration process.

A method for harmless treatment and regeneration of waste liquid discharge during a water glass mold shell hardened with ammonium chloride solution employing a device for harmless treatment and regeneration of waste liquid discharge during a water glass mold shell hardened with ammonium chloride solution includes the following steps:

Step (1). Ammonium chloride waste liquid discharge during a water glass mold shell hardened is stored in the waste liquid storage tank (1).

Step (2). The ammonium chloride waste liquid stored in the waste liquid storage tank (1) is conveyed to the filtering mechanism for filtering treatment, the ammonium chloride waste liquid passes through a first-stage filter and a second-stage filter in turn, so as to remove solid particles from the ammonium chloride waste liquid.

Step (3). The ammonium chloride waste liquid filtered by the filtering mechanism is conveyed to the regeneration mechanism for regeneration treatment, the ammonium chloride waste liquid after the filtering treatment is heated and decomposed in a fractionator, and the generated ammonia gas and hydrogen chloride gas, after being condensed, flow into an absorption tank to be reabsorbed by water in the absorption tank, thus obtaining regeneration liquid.

Step (4). Chemical components in the regeneration liquid are sampled, analyzed and detected through a batching port at the top of a liquid mixing barrel, and ammonia water, hydrochloric acid, or ammonium chloride solution is added into the liquid mixing barrel according to analysis and detection results, so as to obtain ammonium chloride regeneration liquid with a target concentration.

Step (5). The ammonium chloride regeneration liquid obtained from the regeneration treatment of the regeneration mechanism is conveyed to a regeneration liquid storage tank (10) for storage and standby.

When the harmless treatment and regeneration of the ammonium chloride waste liquid is completed, the air is introduced into the filtering mechanism and the regeneration mechanism to wash residual waste gas and waste liquid in a pipeline. Quartz powder filled in the filtering mechanism as the filter medium, is sieved to be used as refractory powder for manufacturing the mold shell. The liquid remaining after decomposition in the regeneration mechanism is concentrated and crystallized to obtain sodium chloride, a by-product.

According to the harmless treatment and regeneration method of the waste liquid discharge during the water glass mold shell hardened with the ammonium chloride solution provided by the present disclosure, solid particle impurities and high-content NaCl components in the hardener waste liquid can be separated and removed in time, and complete regeneration of the hardener waste liquid can be achieved through separation, and regulation of components and physical and chemical properties, thus the problems of increasing pollution caused by the repeated use of the hardener solution in the process of the existing ammonium chloride solution water glass mold shell making, the changes of the physical and chemical properties of the hardener solution with the frequency of use, the great fluctuation of the hardening characteristics of the mold shell, and the large discharge of the hardener waste liquid, can be effectively avoided. The near zero emission in the treatment of waste liquid discharge during the water glass mold shell hardened with ammonium chloride solution is achieved, and the environmental protection is facilitated. Meanwhile, as the hardener waste liquid is treated and regenerated in time, the physical and chemical properties are stable and the hardening rate of the mold shell is controllable, the stability of the performance of the water glass mold shell can be improved, the reject rate can be reduced, and the production cost can be reduced.

Apparently, above embodiments are only examples for clear explanation, rather than limiting the implementation. For those skilled in the art, other changes or variations in different forms may also be made on the basis of the above description. It is not necessary and impossible to exhaust all the implementations here. However, the obvious changes or variations derived therefrom are still within the scope of protection claimed by the present disclosure.

What is claimed is:

1. A device for harmless treatment and regeneration of waste liquid discharge during a water glass mold shell hardened with ammonium chloride solution, the device comprising:
a waste liquid storage tank;
a filtering mechanism;
a regeneration mechanism; and
a regeneration liquid storage tank,
wherein a fluid outlet end of the waste liquid storage tank is in fluid communication with a fluid inlet end of the filtering mechanism, a fluid outlet end of the filtering mechanism is in fluid communication with a fluid inlet end of the regeneration mechanism, and a fluid outlet end of the regeneration mechanism is in fluid communication with a fluid inlet end of the regeneration liquid storage tank.

2. The device for harmless treatment and regeneration of waste liquid discharge during a water glass mold shell hardened with ammonium chloride solution according to claim 1, wherein the filtering mechanism includes a first-stage filter, and a second-stage filter; a first fluid inlet end of the first-stage filter being in fluid communication with the fluid outlet end of the waste liquid storage tank, a fluid outlet end of the first-stage filter being in fluid communication with a fluid inlet end of the second-stage filter, and a fluid outlet end of the second-stage filter being in fluid communication with the fluid inlet end of the regeneration mechanism.

3. The device for harmless treatment and regeneration of waste liquid discharge during a water glass mold shell hardened with an ammonium chloride solution according to claim 2, wherein the first-stage filter is filled with large-sized quartz powder as a filter medium, a height of a filter medium column being greater than or equal to 300 millimeters, and the filter medium being sieved through a 200-mesh screen; and the first fluid inlet end of the first-stage filter being in fluid communication with a top of the filter medium column, and the fluid outlet end of the first-stage filter being in fluid communication with a bottom of the filter medium column.

4. The device for harmless treatment and regeneration of waste liquid discharge during a water glass mold shell hardened with ammonium chloride solution according to claim 2, wherein the second-stage filter is filled with small-sized quartz powder as a filter medium, a height of a filter medium column being greater than or equal to 300 millimeters, and the filter medium being sieved through a 325-mesh screen; and a fluid inlet end of the second-stage filter being in fluid communication with a top of the filter medium column, and the fluid outlet end of the second-stage filter being in fluid communication with a bottom of the filter medium column.

5. The device for harmless treatment and regeneration of waste liquid discharge during a water glass mold shell hardened with ammonium chloride solution according to claim 2, wherein the filtering mechanism further comprises an air compressor pump, and an air outlet end of the air compressor pump being in fluid communication with a second fluid inlet end of the first-stage filter.

6. The device for harmless treatment and regeneration of waste liquid discharge during a water glass mold shell hardened with ammonium chloride solution according to claim 1, wherein the regeneration mechanism includes a fractionator, a heater (5), an absorption tank, and a liquid mixing barrel; a fluid inlet end of the fractionator being in fluid communication with the fluid outlet end of the filtering mechanism, a fluid outlet end of the fractionator being in fluid communication with a fluid inlet end of the absorption tank, a fluid outlet end of the absorption tank being in fluid communication with a fluid inlet end of the liquid mixing barrel, and a fluid outlet end of the liquid mixing barrel being in fluid communication with the fluid inlet end of the regeneration liquid storage tank; and the fractionator being fixedly installed in a heating medium of the heater.

7. The device for harmless treatment and regeneration of waste liquid discharge during a water glass mold shell hardened with ammonium chloride solution according to claim 6, wherein the regeneration mechanism further includes a pH meter and a sampling bottle; a composite electrode of the pH meter extending below a liquid level in the sampling bottle; and a fluid inlet end of the sampling bottle being in fluid communication with a fluid outlet end of the liquid mixing barrel.

8. The device for harmless treatment and regeneration of waste liquid discharge during a water glass mold shell hardened with ammonium chloride solution according to claim 6, wherein the fractionator is a spherical fractionator, an included angle between a condensation branch of the spherical fractionator and a neck part of the spherical fractionator located below the condensation branch being in a range of about 45 degrees to about 70 degrees; the heater being a magnetic stirring oil bath heater, with a temperature control range of about 100 degrees Celsius to about 260 degrees Celsius; a batching port being formed at a top of the liquid mixing barrel; and an absorption medium being arranged in the absorption tank.

9. A method for harmless treatment and regeneration of waste liquid discharge during a water glass mold shell hardened with ammonium chloride solution, wherein the method is realized by using a device for harmless treatment and regeneration of waste liquid discharge during a water glass mold shell hardened with ammonium chloride solution, the device including a waste liquid storage tank, a filtering mechanism, a regeneration mechanism, and a regeneration liquid storage tank, wherein a fluid outlet end of the waste liquid storage tank is in fluid communication with a fluid inlet end of the filtering mechanism, a fluid outlet end of the filtering mechanism is in fluid communication with a fluid inlet end of the regeneration mechanism, and a fluid outlet end of the regeneration mechanism is in fluid communication with a fluid inlet end of the regeneration liquid storage tank, and the method comprises the following steps:
Step (1): storing ammonium chloride waste liquid discharge during the water glass mold shell hardened in the waste liquid storage tank (1);
Step (2): conveying the ammonium chloride waste liquid in the waste liquid storage tank (1) to the filtering mechanism for filter treatment, so as to remove solid particles from the ammonium chloride waste liquid;
Step (3): conveying the ammonium chloride waste liquid filtered by the filtering mechanism to the regeneration mechanism for regeneration treatment, so as to decompose ammonium chloride in the ammonium chloride waste liquid to produce ammonia gas and hydrogen chloride gas, and absorbing the ammonia gas and hydrogen chloride gas by distilled water to obtain regeneration liquid;
Step (4): analyzing and detecting chemical components in the regeneration liquid, and adding ammonia water, hydrochloric acid, or ammonium chloride solution into the regeneration liquid according to analysis and detection results to obtain ammonium chloride regeneration liquid with a target concentration; and
Step (5): conveying the ammonium chloride regeneration liquid obtained from the regeneration treatment of the regeneration mechanism to a regeneration liquid storage tank (10) for storage and standby.

10. The method for harmless treatment and regeneration of waste liquid discharge during a water glass mold shell hardened with ammonium chloride solution according to claim 9, wherein the filtering mechanism includes a first-stage filter, and a second-stage filter; a first fluid inlet end of the first-stage filter being in fluid communication with the fluid outlet end of the waste liquid storage tank, a fluid outlet end of the first-stage filter being in fluid communication with a fluid inlet end of the second-stage filter and a fluid outlet end of the second-stage filter being in fluid communication with the fluid inlet end of the regeneration mechanism.

11. The method for harmless treatment and regeneration of waste liquid discharge during a water glass mold shell hardened with ammonium chloride solution according to claim 10, wherein the first-stage filter is filled with large-sized quartz powder as a filter medium, a height of a filter medium column being greater than or equal to 300 millimeters, and the filter medium being sieved through a 200-mesh screen; and the first fluid inlet end of the first-stage filter being in fluid communication with a top of the filter medium column, and the fluid outlet end of the first-stage filter being in fluid communication with a bottom of the filter medium column.

12. The method for harmless treatment and regeneration of waste liquid discharge during a water glass mold shell hardened with ammonium chloride solution according to claim 10, wherein the second-stage filter is filled with small-sized quartz powder as a filter medium, a height of a filter medium column is greater than or equal to 300 millimeters, and the filter medium being sieved through a 325-mesh screen; and a fluid inlet end of the second-stage filter being in fluid communication with a top of the filter medium column, and the fluid outlet end of the second-stage filter being in fluid communication with a bottom of the filter medium column.

13. The method for harmless treatment and regeneration of waste liquid discharge during a water glass mold shell hardened with ammonium chloride solution according to claim 10, wherein the filtering mechanism further comprises an air compressor pump, an air outlet end of the air compressor pump being in fluid communication with a second fluid inlet end of the first-stage filter.

14. The method for harmless treatment and regeneration of waste liquid discharge during a water glass mold shell hardened with ammonium chloride solution according to claim 9, wherein the regeneration mechanism comprises a fractionator, a heater, an absorption tank, and a liquid mixing barrel; a fluid inlet end of the fractionator being in fluid communication with the fluid outlet end of the filtering mechanism, a fluid outlet end of the fractionator being in fluid communication with a fluid inlet end of the absorption tank, a fluid outlet end of the absorption tank being in fluid communication with a fluid inlet end of the liquid mixing barrel, and a fluid outlet end a of the liquid mixing barrel being in fluid communication with the fluid inlet end of the regeneration liquid storage tank; and the fractionator being fixedly installed in a heating medium of the heater.

15. The method for harmless treatment and regeneration of waste liquid discharge during a water glass mold shell hardened with ammonium chloride solution according to claim 14, wherein the regeneration mechanism further comprises a pH meter and a sampling bottle; a composite electrode of the pH meter extending below a liquid level in the sampling bottle; and a fluid inlet end of the sampling bottle being in fluid communication with a fluid outlet end of the liquid mixing barrel.

16. The method for harmless treatment and regeneration of waste liquid discharge during a water glass mold shell hardened with ammonium chloride solution according to claim 14, wherein the fractionator is a spherical fractionator, an included angle between a condensation branch of the spherical fractionator and a neck part of the spherical fractionator located below the condensation branch being in a range of about 45 degrees to about 70 degrees; the heater being a magnetic stirring oil bath heater, with a temperature control range of about 100 degrees Celsius to about 260 degrees Celsius; a batching port being formed at a top of the liquid mixing barrel; and an absorption medium being arranged in the absorption tank.

17. The method for harmless treatment and regeneration of waste liquid discharge during a water glass mold shell hardened with ammonium chloride solution according to claim 9, further comprising the following steps:
introducing air into the filtering mechanism and the regeneration mechanism to wash residual waste gas and waste liquid in a pipeline, when the harmless treatment and regeneration of the ammonium chloride waste liquid is completed;
sieving quartz powder filled in the filtering mechanism as the filter medium to be used as refractory powder for manufacturing the mold shell; and
concentrating and crystallizing liquid remaining after decomposition in the regeneration mechanism to obtain a sodium chloride by-product.

18. The method for harmless treatment and regeneration of waste liquid discharge during a water glass mold shell hardened with ammonium chloride solution according to claim 10, further comprising the following steps:
introducing air into the filtering mechanism and the regeneration mechanism to wash residual waste gas and waste liquid in a pipeline, when the harmless treatment and regeneration of the ammonium chloride waste liquid is completed;
sieving quartz powder filled in the filtering mechanism as the filter medium to be used as refractory powder for manufacturing the mold shell; and
concentrating and crystallizing liquid remaining after decomposition in the regeneration mechanism to obtain a sodium chloride by-product.

19. The method for harmless treatment and regeneration of waste liquid discharge during a water glass mold shell hardened with ammonium chloride solution according to claim 11, further comprising the following steps:
introducing air into the filtering mechanism and the regeneration mechanism to wash residual waste gas and waste liquid in a pipeline, when the harmless treatment and regeneration of the ammonium chloride waste liquid is completed;
sieving quartz powder filled in the filtering mechanism as the filter medium to be used as refractory powder for manufacturing the mold shell; and
concentrating and crystallizing liquid remaining after decomposition in the regeneration mechanism to obtain a sodium chloride by-product.

20. The method for harmless treatment and regeneration of waste liquid discharge during a water glass mold shell hardened with ammonium chloride solution according to claim 12, further comprising the following steps:
introducing air into the filtering mechanism and the regeneration mechanism to wash residual waste gas and waste liquid in a pipeline, when the harmless treatment and regeneration of the ammonium chloride waste liquid is completed;
sieving quartz powder filled in the filtering mechanism as the filter medium to be used as refractory powder for manufacturing the mold shell; and
concentrating and crystallizing liquid remaining after decomposition in the regeneration mechanism to obtain a sodium chloride by-product.
